(19) United States
(12) Patent Application Publication
(10) Pub. No.: US 2009/0314644 A1
(43) Pub. Date: Dec. 24, 2009

(54) Method and Device for Electrokinetic Manipulation

(75) Inventors: Saar Golan, Haifa (IL); Uri Dinnar, Haifa (IL); David Elata, Haifa (IL); Meir Orenstein, Haifa (IL)

Correspondence Address: MARTIN D. MOYNIHAN d/b/a PRTSI, INC., P.O. BOX 16446, ARLINGTON, VA, 22215, US

(73) Assignee: Technion Research & Development Foundation Ltd., Haifa (IL)

(21) Appl. No.: 12/225,880

(22) PCT Filed: Apr. 10, 2007
(86) PCT No.: PCT/IL2007/000460

§ 371 Date: May 5, 2009

Related U.S. Application Data
(60) Provisional application No. 60/790,547, filed on Apr. 10, 2006.

(51) Int. Cl. B01D 57/02; B05D 5/12

(52) U.S. Cl. 204/643; 204/600; 427/58

(57) ABSTRACT

A device for manipulating an object present in a fluid by electrokinetics is disclosed. The device comprises a substrate forming a flow chamber. The device further comprises a plurality of electrically biasable electrode structures and at least one electrically floating electrode structure.

### FIELD AND BACKGROUND OF THE INVENTION

The present invention relates to object manipulation and, more particularly to a method and device for manipulating small scale objects by electrokinetics.

Electrokinetics is the use of electrical fields (and the resulting forces) to manipulate matter in a fluid medium. Electrokinetics is a term which encompasses all types of processes in which the application of electric field results in motion of matter.

One type of electrokinetics is electrophoresis. Electrophoresis is a phenomenon in which charged particles, located between two electrically biased electrodes, are influenced by the electric field generated by the electrodes such that they are attracted to one electrode and repulsed by the other electrode. The attracting and repulsing forces are proportional to the particle net charge and the electric field magnitude.

Another type of electrokinetics is dielectrophoresis. Dielectrophoresis is the motion of matter caused by polarization effects in a nonuniform electric field. Electric fields induce dielectric polarization components in polarizable particles. The extent of the particle's polarization is related to its effective dielectric constant (polarizability) and to the electric field magnitude. Particles that have high dielectric constants experience significant polarization while particles that have low dielectric constants experience lower polarization. In dielectrophoresis, particle motion is produced by the interaction between the nonuniform electric field and the dielectric polarization components induced in the particle and in the surrounding fluid medium by the field. In a uniform field, neutral particles, including neutral polarized particles, experience no net electric force. However, when placed in a nonuniform field polarizable, particles experience a net force in the direction of the field gradient, tending to move the particles towards regions of higher electric field strength. This motion is known as positive dielectrophoresis. If the polarizability of the suspension medium exceeds that of the particles, they tend to move towards regions of lower electric field strength. This motion is known as negative dielectrophoresis.

The principle of dielectrophoresis has become a popular technique for separating objects such as biological cells or microparticles in suspension. The ability to identify, characterize and purify cell subpopulations is fundamental to numerous biological and medical applications, often forming the starting point for research protocols and the basis for current and emerging clinical protocols. Cell separation has numerous applications in medicine, biotechnology and environmental study. For example, cell separation can make possible life-saving procedures such as autologous bone marrow transplantation for the remediation of advanced cancers in which the removal of cancer-causing metastatic cells from a patient's marrow is necessary. In other applications, such as the study of signaling between blood cells, highly purified cell subpopulations permit studies that would otherwise be impossible. A key advantage of dielectrophoretic separation over currently used separation techniques (such as the isolation of cells according to cell density, specific immunologic targets or receptor-ligand interactions), is that dielectrophoresis effectively maps biophysical properties into electrostatic forces whose direction and magnitude reflect cellular properties. The analysis of the dielectrophoretic motion of cells thus permits: biophysical parameters, such as capacitance and surface conductance, to be probed.

Dielectrophoretic forces are generated by either conventional dielectrophoresis (cDEP, also termed classic dielectrophoresis or simply dielectrophoresis) or by traveling-wave dielectrophoresis (twDEP). Classic dielectrophoresis refers to motion arising from nonuniform distribution in the magnitude of a direct-current (DC) or alternating-current (AC) electric field. Traveling-wave dielectrophoresis refers to motion arising from nonuniform distribution in the phase of an alternating-current electric field.

The nonuniform electric fields required for the implementation of dielectrophoresis are typically generated by microelectrodes connected via electrical contacts to an AC or DC power source. Known in the art are two major techniques for generating nonuniform electric fields.

In one such techniques, the electrodes are arranged in a specialized geometry such as a castellated arrangement [Green, N. G., Morgan, H., J. Phys. D 1998, 31, L25-L30; and Morgan, H., Hughes, M. P., Green, N. G., Biophys. J. 1999, 77, 516 525]. These geometries are characterized by a variable distance between the electrodes, such that the electric field is higher in regions in which the electrodes are closer and lower in regions in which the electrodes are farther apart. This results in nonuniform electric fields.

In another techniques, the electrodes are arranged in a symmetric geometry, and the motion of particles is achieved by subjecting them to a specific voltage [Li, H., Bashir, R., Sensors and Actuators 2002, 86, 215-221; Talary, M. S., Burt, J. P. H., Tame, J. A., Pethig, R., J. Phys. D 1996, 29, 2198-2203; Xu, J. Q., Wu, L., Huang, M., Yang, W., Cheng, J., Wang, X., in: Micro Total Analysis Systems, Monterey 2001, pp. 565-566; and Wang, X., Yang, J., Huang, Y., Vykoukal, J., Becker, F. F., Gascoyne, P. R. C., Anal. Chem. 2000, 72, 832-839]. The applied voltage is in the form of a pulse sequence, which is typically characterized by constant amplitude and half-cycle or quarter-cycle phase sequence. The operation of devices employing a half-cycle phase sequence is based on classic dielectrophoresis and the dielectrophoretic force produced thereby is perpendicular to the electrode plane. The operation of devices employing a quarter-cycle phase sequence is based on traveling wave dielectrophoresis and the dielectrophoretic force produced thereby is parallel to the electrode plane.

It is generally difficult to manufacture dielectrophoretic devices, inter alia due to the need to establish electrical contact between the microelectrodes generating the nonuniform field and the external power source. The electrodes are typically connected by metal traces to peripheral pads where electrical contacts with a signal generator are established. Attempts have been made to reduce the number of external electrical contacts in dielectrophoretic devices, by employing interdigitated electrode arrays. However, this approach may necessitate complex photolithography and repeated metal evaporation processes and is therefore costly and technologically demanding. For these reasons, dielectrophoretic devices have met with little commercial acceptance.

There is thus a widely recognized need for, and it would be highly advantageous to have, a method and device for manipulating objects by electrokinetics devoid of the above limitations.

### SUMMARY OF THE INVENTION

According to one aspect of the present invention there is provided a device for manipulating an object present in a fluid by electrokinetics. The device comprises a substrate forming a flow chamber and having formed thereon or being integrated with a plurality of electrically biasable electrode structures and at least one electrically floating electrode structure.

According to further features in preferred embodiments of the invention described below, the electrically floating electrode structure(s) is designed and configured to control non-uniformities in an electric field generated upon application of bias to the plurality of electrically biasable electrode structures.

According to still further features in the described preferred embodiments the electrically floating electrode structure(s) is designed and configured to increase non-uniformities in an electric field generated upon application of bias to the plurality of electrically biasable electrode structures.

According to another aspect of the present invention there is provided a method of manipulating an object present in a fluid by electrokinetics, comprising contacting the fluid with the device, and applying bias to the plurality of electrically biasable electrode structures so as to generate a nonuniform electric field, thereby manipulating the object.

According to still another aspect of the present invention there is provided apparatus for manipulating an object present in a fluid by electrokinetics. The apparatus comprises: a substrate forming a flow chamber and having formed thereon or being integrated with at least one electrically floating electrode structure; and an electrically activable device, having a plurality of electrically biasable electrode structures and being designed and constructed to receive the substrate and to generate an electric field in a region engaged by the substrate.

According to further features in preferred embodiments of the invention described below, the electrically floating electrode structure(s) is designed and configured to control non-uniformities in the electric field.

According to still further features in the described preferred embodiments the electrically floating electrode structure(s) is designed and configured to increase non-uniformities in the electric field.

According to an additional aspect of the present invention there is provided a method of fabricating a device for manipulating an object by electrokinetics. The method comprises: fabricating a plurality of electrode structures in a chamber; fabricating a plurality of electrical contacts in the chamber; and connecting a portion of the plurality of electrode structures to the plurality of electrical contacts, so as to provide a plurality of electrically biasable electrode structures while maintaining and at least one electrically floating electrode structure, the electrically floating electrode structure(s) being designed and configured to increase non-uniformities in an electric field generated upon activation of the plurality of electrically biasable electrode structures.

According to further features in preferred embodiments of the invention described below, at least one of the plurality of electrically biasable electrode structures and the at least one floating electrode structure is characterized by at least one micrometric dimension. According to still further features in the described preferred embodiments at least one of the plurality of electrically biasable electrode structures and the at least one floating electrode structure is characterized by at least one nanometric dimension. According to still further features in the described preferred embodiments the electrically biasable electrode structures are characterized by at least one micrometric dimension and the at least one floating electrode structure is characterized by at least one nanometric dimension.

According to still further features in the described preferred embodiments the electrically floating electrode structure(s) is designed and constructed to increase a dielectrophoretic force exerted on the object by at least one, more preferably at least two, more preferably at least three orders of magnitude. According to still further features in the described preferred embodiments at least one electrically floating electrode structure is designed and constructed to increase a dielectrophoretic force exerted on the object by more than three orders of magnitude.

According to still further features in the described preferred embodiments the electrically biasable electrode structures comprise interdigitated electrodes.

According to still further features in the described preferred embodiments the electrically floating electrode structures comprise carbon nanotubes.

According to still further features in the described preferred embodiments the device or apparatus further comprises a power source device, electrically connected to the plurality of electrically biasable electrode structures and configured for applying bias thereto.

According to still further features in the described preferred embodiments the power source device is configured to provide out-of-phase signals to individual members of the plurality of electrodes.

According to still further features in the described preferred embodiments the out-of-phase signals are selected such as to generate a traveling wave dielectrophoretic force.

According to still further features in the described preferred embodiments the out-of-phase signals are selected such as to generate a classical dielectrophoretic force.

According to still further features in the described preferred embodiments the power source device is a direct-current power source device.

According to still further features in the described preferred embodiments device or apparatus further comprises a detector for detecting the presence of the object.

According to still further features in the described preferred embodiments the detector is designed and constructed for detecting variations in the electrical characteristics in a predetermined region within the chamber.

According to still further features in the described preferred embodiments the detector is designed and constructed for detecting variations in the optical characteristics in a predetermined region within the chamber.

According to still further features in the described preferred embodiments the device or apparatus further comprises at least one inlet port and at least one outlet port, the at least one inlet port and the at least one outlet port being in fluid communication with the chamber, and a fluid flow system for supplying the fluid to the at least one inlet port and removing the fluid from at least one outlet.

According to still further features in the described preferred embodiments the object is made of organic material.

According to still further features in the described preferred embodiments the object is made of non-organic material.

According to still further features in the described preferred embodiments the object comprises a biological molecule.

According to still further features in the described preferred embodiments the object comprises a non-biological molecule.

According to still further features in the described preferred embodiments the fluid is a biological fluid.

According to still further features in the described preferred embodiments the fluid is a non-biological fluid.

According to still further features in the described preferred embodiments the object is selected from the group consisting of a cell, cell aggregate, cell organelle, nucleic acid, bacterium, protozoan and virus.

According to still further features in the described preferred embodiments the object is an aggregate of inorganic matter.

According to still further features in the described preferred embodiments the object is an organic material, isomer thereof or isotope thereof.

According to still further features in the described preferred embodiments the object is suspended inorganic matter.

According to still further features in the described preferred embodiments the object is dissolved inorganic matter.

The present invention successfully addresses the shortcomings of the presently known configurations by providing a device, apparatus and method for manipulating an object by electrokinetics.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of a device for manipulating an object present in a fluid, according to various exemplary embodiments of the present invention;

FIG. 2a is a schematic illustration of a microfluidic device, according to various exemplary embodiments of the present invention;

FIG. 2b is a schematic illustration of an apparatus for manipulating an object present in a fluid, according to various exemplary embodiments of the present invention;

FIG. 3 is a is a schematic illustration of a device for manipulating an object in an exemplified embodiment in which the device comprises two electrically biasable electrode structures and a electrically floating cylindrical electrode structure;

FIGS. 4a-b illustrate electric field and the normalized field intensity gradients for the device of FIG. 3;

FIG. 4c shows the field intensity gradients in the vicinity of the cylindrical floating electrode structure of the device of FIG. 3, as a function of the radius of the cylinder;

FIGS. 5a-d are schematic illustrations of model devices used in computer simulations;

FIGS. 6a-8h show results of computer simulations corresponding to the model devices of FIGS. 5a-d;

FIG. 9 shows the effect of the distance between the biased electrodes on the field intensity and field intensity gradient at the floating electrode edges, as calculated from the results of the computer simulations; and

FIGS. 10a-b are two video images captured in experiments performed using prototype devices manufactured according to various exemplary embodiments of the present invention.

### DESCRIPTION OF THE PREFERRED EMBODIMENTS

The present embodiments comprise a device and method which can be used to manipulate objects by electrokinetics. Specifically, but not exclusively, the present embodiments can be used to manipulate small scale objects by dielectrophoresis. The present embodiments further comprise a method suitable for manufacturing a device for manipulating an object.

The principles and operation of a device and method according to the present embodiments may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

While the embodiments below are described with a particular emphasis to dielectrophoretic forces, it is to be understood that a more detailed reference to dielectrophoresis is not to be interpreted as limiting the scope of the invention in any way. The device and method of the present embodiments can therefore be used to manipulate electrically neutral as well as charged objects, which can be conductive, dielectric or semiconductive. The manipulated objects can be made of any material, including, without limitation, inorganic material e.g., minerals, crystals, colloidal and gas bubbles, organic material or biological material e.g., cells, nucleic acids, bacteria, protozoans and viruses. The manipulated objects can also be in the form of cell aggregates, cell organelles, molecules or molecular aggregates, such as, but not limited to, proteins and nucleic acids.

While being manipulated according to various exemplary embodiments of the present invention, the objects are typically present in a fluid, such as, but not limited to, water, a biological fluid (for example, body fluid, e.g., blood, plasma, urine, saliva, vaginal secretions, feces and wound excrement), a bacterial cell suspension, a protein medium, an antibody medium, a nucleic acid medium, ink and the like and fluid media commonly used in standard medical applications such as phosphate buffered saline. The fluid may include more than one type of objects, such as, but not limited to, a mixture of cell types. The device and method manipulate the objects by applying forces so as to change their kinematical properties. Depending on their various characteristics (size, mass, electrical properties, etc.), different types of objects may have different responses to the forces applied by the device and method of the present embodiments. Thus, the device and method of the present embodiments can be used to discriminate between distinctive types of objects because the analysis of the kinematical properties of the manipulated objects (position, velocity, acceleration) allows to identify their various characteristics or at least to separate the objects according to their different kinematical properties. For example, the present embodiments can be used to manipulate erythrocytes in a blood sample, abnormal erythrocytes (e.g., erythrocyte infested with malaria) in a blood sample containing normal and abnormal erythrocytes, fetal nucleated red blood cells in a mixture of maternal blood, cancer cells in a mixture with normal cells.

The present embodiments are useful to manipulated objects of any size. In particular, the present embodiments are useful for particles in the sub-millimeter scale. A characteristic length scale for the manipulated particles can therefore be from about 1 nm to about 500 μm, more preferably from about 10 nm to about 50 μm, more preferably from about 10 nm to about 1 μm.

As used herein the term “about” refers to ±20%.

Small size particles can be, for example, chemical or biological molecules (including proteins, DNA, RNA, antibodies, antigens and lipids), assemblages of molecules, viruses, plasmids, bacteria, cells or cell aggregates, protozoans, embryos or other small organisms, as well as non-biological molecules, assemblages thereof, minerals, crystals, colloidal, conductive, semiconductive or dielectric particles and gas bubbles.

As demonstrated in the Examples section that follows, the device and method of the present embodiments are capable of separating cells without the need to alter them with ligands, stains, antibodies or other means. Cells remain undamaged, unaltered and viable during and following separation. Non-biological applications similarly require no such alteration. It is to be understood, however, that the device and method of the present embodiments are also suitable for separating the objects even if they have been so altered.

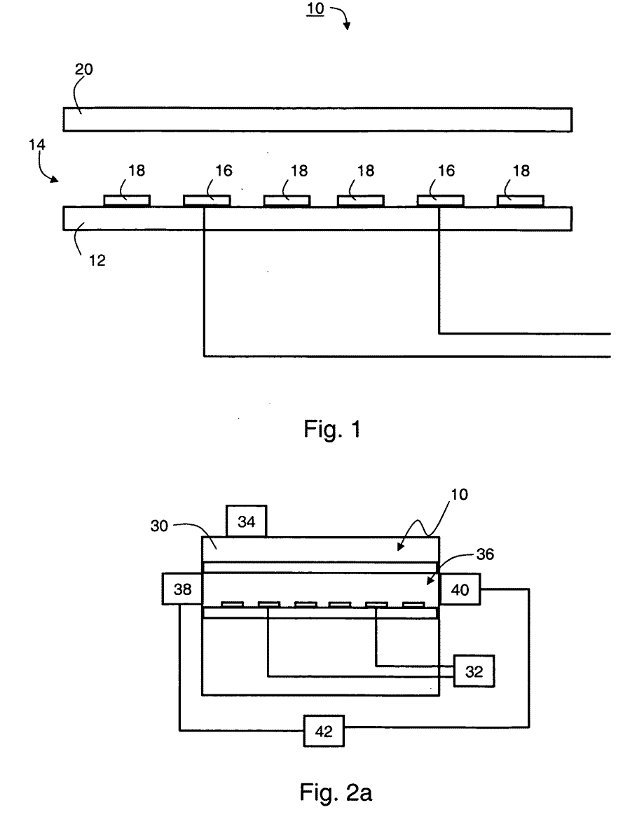

Referring now to the drawings, FIG. 1 illustrates a device 10 for manipulating an object present in a fluid, according to various exemplary embodiments of the present invention. Device 10 comprises a substrate 12 forming a flow chamber shown generally at 14. Device 10 further comprises a plurality of electrically biasable electrode structures 16 and one or more electrically floating electrode structures 18. Electrode structures 16 and 18 are formed on or integrated with substrate 12.

As used herein, the term “floating electrode structure” refers to an electrode structure that is separated from a conductive or semiconductive body by an intervening dielectric having thickness and other properties selected to substantially prevent flow of charge carriers to the electrode structure.

As used herein, the term “biasable electrode structure” refers to an electrode structure that is configured to be electrically connected to a power source, e.g., via a contact pad or the like, in a manner such that upon activation of the power source, charge carriers flow from the power source to the electrode structure or from the electrode structure to the power source, and the electrode structure becomes electrically biased.

Optionally and preferably, device 10 comprises an additional substrate 20, spaced apart from substrate 12 such that flow chamber 14 is defined between substrates 12 and 20. For example, substrates 12 and 20 can be planar substrates engaging different planes and flow chamber 14 can be defined in the volume between the two different planes.

Shown in FIG. 1 is a six electrode structure configuration with six parallel electrode structures such that the two outermost structures are floating electrode structures, the two next-to-outermost structures are biasable electrode structures and the two innermost structures are floating electrode structures positioned between the biasable electrode structures. It is to be understood, however, that it is not intended to limit the scope of the present invention to the configuration illustrated in FIG. 1, and that device 10 can comprise any number of electrode structures in any orientation, provided there is at least one floating electrode structure and at least two biasable electrode structures. Thus, in the simplest configuration, device 10 comprises a pair of biasable electrode structures and a single floating electrode structure. In this embodiment, the floating electrode is preferably, but not obligatorily, positioned between the biasable electrodes.

Unless specifically indicated, the singular form “electrode structure” applies also to a plurality of electrode structures and vice versa.

Substrates 12 and 20 are made of electrically insulating or dielectric material which is preferably, but not obligatorily transparent to visible light to allow monitoring locomotion of objects within the device by visual or other optical means. Representative example of materials suitable for substrate 12 and 20 include, without limitation, glass, silicon dioxide, resistive (non-conductive) silicon, plastics (such as, but not limited to, those used for printed circuit board substrates), elastomers (e.g., poly-dimethylsiloxane), insulating photoresists (e.g., SU-8) ceramic or the like.

The electrode structures of device 10 can be made of any electrically conductive material such as, but not limited to, evaporated metal layers, conductive polymers, photoelectric materials or the like. The electrode structures may be in direct contact with the fluid or fluids, or they may be separated from them by a thin passivation layer or layers (e.g., a film of SiO₂, a photoresist, an elastomer, an adhesive, silicon nitride or a biologically selective and functional layer).

The floating electrode structure of device 10 is designed and configured to increase and/or control nonuniformities in the electric field generated upon application of bias to the electrically biasable electrode structures. In various exemplary embodiments of the invention the floating electrode is designed and configured to provide a predetermined nonuniform electric field distribution in chamber 14. The control and/or increment of the eclectic field non-uniformity can be done by selecting the number, shape, size, material and/or position of the floating electrode structure. Nonuniform electric field is particularly useful when it is desired to use device 10 for manipulating neutral objects. In this case, the nonuniform electric field exerts dielectrophoretic forces on the objects.

As demonstrated in the Examples section that follows, the floating electrode structure can significantly increase the dielectrophoretic force exerted on the object. According to a preferred embodiment of the present invention the floating electrode structure is designed and constructed to increase the dielectrophoretic force by at least one, more preferably at least two most preferably at least three orders of magnitude. In other embodiments, the dielectrophoretic force is increased by more than three orders of magnitude. Since in operation there is no bias which is applied to the floating electrode structure, the increment of the dielectrophoretic force, via the field intensity gradients, is achieved without increasing the applied bias and/or substantially increasing the electric field.

The amount by which the floating electrode structure increases the nonuniformity of the electric field in the device can be obtained experimentally, by analytic calculations and/or by numeric simulations. For example, device 10 and another device, similar to device 10 but with no floating electrode structure (or with the floating electrode structure replaced by a biasable electrode structure), can be manufactured and connected to a power source so as to generate electric field. Nonuniformities in the electric fields within the two devices can then be measured and compared to ensure that the floating electrode structure increases nonuniformities. Alternatively or additionally, the effect of the floating electrode structure can be determined by numerical simulation or theoretical analysis. Thus, the nonuniformity in the electric field for two similar devices, with and without floating electrode structure, can be calculated or numerically simulated and compared to ensure that the floating electrode structure increases nonuniformities.

The biasable and floating electrode structures can be of any size and shape. In one embodiment, the biasable and floating electrode structures are characterized by one or more micrometric dimensions. For example, the biasable and floating electrode structures can be linear electrodes having a width of from about 5 μm to about 150 μm, a length of from about 100 μm to about 2.5 mm and a thickness of from about 10 nm to about 1 μm.

In another embodiment, the biasable electrode structures are characterized by one or more micrometric dimensions, and the floating electrode structures are characterized by one or more nanometric dimensions. For example, the biasable electrode structures can be of the shape and size described above and the floating electrode structure can be, or it can be formed of nanostructures, such as, but not limited to, carbon nanotubes, e.g., fullerene carbon nanotubes which can be, either single-walled or multi walled nanotubes. This embodiment combines the advantage of micrometric biasable electrode structures from the standpoint of relatively simple manufacturing process with the advantage of nanometric floating electrode structures from the standpoint of relatively large obtainable non-uniformities in the electric field. For example, non-uniformities obtainable using a device having two linear micrometric electrode structures and two linear nanometric electrode structures are larger by approximately three orders of magnitude in comparison with nonuniformities obtainable using a device having four linear micrometric electrode structures.

Also contemplated is a configuration in which the floating as well as biasable electrode structures are characterized by one or more nanometric dimensions.

The electrically biasable electrode structures can be of any shape and can be arranged in any geometrical configuration. For example, the electrically biasable electrode structures can be interdigitated electrodes.

The term “interdigitated” means that a plurality of “digits” of a first electrode group is disposed alternately with a plurality of “digits” of a second electrode group. The geometry, dimensions and overall shape of the interdigitated electrodes may vary in different embodiments.

Before providing a further detailed description of the present embodiments, attention will be given to the advantages and potential applications offered thereby.

A particular advantage of device 10 is the use of floating electrode structure, since device 10 generally includes fewer connections to external signal sources. The reduced number of connections allows miniaturization and improves conventional devices at least from the standpoint of compactness, since external signal connections tend to be bulky.

As further explained in the Examples section that follows, the dielectrophoretic force is proportional to the volume of the manipulated object. Thus, the dielectrophoretic forces experienced by small objects are significantly lower than the dielectrophoretic forces experienced by larger objects. For example, the dielectrophoretic forces experienced by nanoparticles are about 10⁹ times weaker than the dielectrophoretic forces experienced by microparticles.

One traditional approach for manipulating nanoparticles by dielectrophoresis calls for increasing the voltages applied to the electrodes. However, Function generators capable of producing such high voltages are rarely, if at all, attainable. Furthermore, working with too high voltages can be hazardous. Another traditional approach calls for the fabrication of electrodes having much smaller feature sizes and much smaller inter-electrode separation. However, for providing sufficiently high dielectrophoretic forces for the manipulation of nanoparticles, nano-electrodes may have to be fabricated. Such fabrication is known to be difficult, in particular when all the electrodes are connected to external signal sources. The device of the present embodiments successfully overcomes these difficulties because the floating electrodes do not require external signal sources.

An additional improvement presented by the device of the present embodiments is the aforementioned combination of biasable microelectrode structures and floating nanoelectrode structures. The increased dielectrophoretic force in the vicinity of a floating nanoelectrode structure of the present embodiments originates from imposing nanoscale changes on the potential distribution in these areas. As demonstrated in the Examples section that follows, although the floating nanoelectrode structures do not considerably affect the potential and the electric field values, they significantly increase the field intensity gradients. This can be explained as follows: in the vicinity of a generally cylindrical floating electrode structure, the electric field intensity does not depend on the radius of the electrode structure, but the gradient of the electric field is inversely proportional to this radius.

The gradient in the vicinity of a nanoelectrode structure is therefore about three orders of magnitude higher than in the vicinity of a microelectrode structure. Thus, in the embodiments in which the biasable electrode structures are of micrometric scale and the floating electrode structures are of nanometric scale, the electric field gradient near the floating electrode structures is significantly higher than near the biasable electrode structures. Such configuration allows obtaining a local increase in dielectrophoretic forces without having to increase the voltages applied to the biasable electrode structures.

An additional advantage of the technique of the present embodiments is the ability to provide high field gradients at many geometrical configurations of the biasable electrodes. This is because the high field gradients are local (near the floating electrodes) and it is not necessary to generate high field gradients near the biasable electrodes. Thus, unlike traditional dielectrophoresis devices for manipulating nanoparticles which are limited to polynomial geometries, the device of the present embodiments can comprise geometrical configurations other than polynomial. For example, the device of the present embodiments can manipulate nanoparticles using, but not limited to, interdigitated biasable electrode structures and/or deflection electrodes and/or castellated electrodes and/or spiral electrodes and/or sinusoidal electrodes.

An additional advantage of the technique of the present embodiments is the ability to increase the density of electrodes in the device by providing more floating electrode structures. Such configuration facilitates the simultaneous manipulation of many particles and offers a higher throughput. When the floating electrode structure is of nanometric scale and the biasable electrode structures as well as the gap between adjacent biasable electrode structures are of micrometric scale, a single gap between adjacent biasable electrode structures can be occupied with numerous floating nanoelectrode structures. Such configuration is inherently suitable for massive parallel processing.

Since the floating electrode structures are not connected to a power source, a large number and high density of electrode structures can be incorporated in the device without or with minimal additional power. Such configuration preserves relatively low Joule heating of the medium in the device. This is particularly advantageous when the manipulated objects are nanoparticles which tend to undergo Brownian motions and are much more susceptive to temperature changes relative to larger objects such as microparticles.

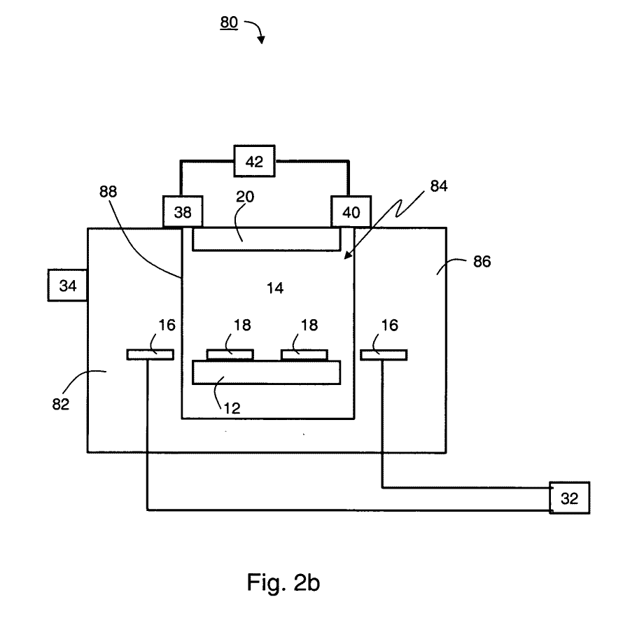

Reference is now made to FIG. 2a which is a schematic illustration of a microfluidic device 30, according to various exemplary embodiments of the present invention. Microfluidic device 30 typically comprises device 10 and can be used for performing many useful tasks, primarily, but not exclusively, in the field of life-science.

For example, a microfluidic device containing device 10 can be used in medical diagnostics, e.g., for processing a volume of sample from a subject (such as a droplet of blood). The sample and/or other small volumes of fluids containing analytes can be moved by electrokinetics (e.g., dielectrophoresis) from reservoirs or other receiving chambers through microchannels of the microfluidic device to one or more reaction or association chambers so as to determine whether the sample contains one or more target molecules of interest (such as DNA from a pathogen).

A microfluidic device containing device 10 can also be configured for use in sampling air to determine the presence of pathogens or poisons by drawing in a sample of air and processing this fluid sample to identify whether, e.g., DNA or another signature of interest (such as proteins uniquely associated with the pathogen) is present.

A microfluidic device containing device 10 can also be used as a sorter or purifier, in which individual cells or molecules of interest are separated from other cells or molecules by size, type, or other criteria.

Device 10 can also be implemented in various kinds of arrays, such as, but not limited to, an oligonucleotide array, where fluids containing labeled target oligonucleotides are moved to a surface of a substrate to which complementary probe oligonucleotides are attached, or protein arrays, where fluids containing labeled proteins are moved to a surface of a substrate to which probe proteins are attached and with which the targets of interest associate.

A microfluidic device containing device 10 can also be used as a chromatograph for performing liquid chromatography.

A microfluidic device containing device 10 can also be used as a microfluidic printing device, in which inks are formed by moving precursors through microchannels.

A microfluidic device containing device 10 can also be used as a microfluidic mixer, in which one or more fluids are moved through a mixer inserted in a microchannel.

A microfluidic device containing device 10 can also be used as an optical device, in which a bubble or slug of fluid immiscible in a second fluid is moved through the second fluid to a spot of optical activity on the substrate.

Referring now again to the FIG. 2a, microfluidic device 30 preferably comprises a power source device 32, which is electrically connected to the biasable electrode structures of device 10 and configured for applying bias thereto. Power source device 32 can be an integral part of device 10 or it can be part of device 30 in which communication between devices 32 and 10 can be established by suitable connection lines, as known in the art.

Power source device 32 can be configured to provide in-phase and/or out-of-phase signals to individual members of the biasable electrodes, to generate a classical or traveling wave dielectrophoresis. Alternatively, power source device 32 can be a direct-current power source device.

In various exemplary embodiments of the invention device 30 comprises one or more inlet ports 38 and one or more outlet ports 40. Inlet port 38 and outlet port 40 are in fluid communication with the chamber of device 10. Optionally and preferably device 30 comprises a fluid flow driving system 42, such as a pump or the like, for supplying fluid to inlet port 38 and removing fluid from outlet port 40. System 42 can comprise, for example, one or more pumps, e.g., micro-pumps.

In various exemplary embodiments of the invention device 30 further comprises a detector 34 for detecting the presence of the object(s) in device 10. Many types of detectors are contemplated. In one embodiment, detector 34 detects variations in the electrical characteristics in a predetermined region 36 within the chamber of device 10; in another embodiment, detector 34 detects variations in the optical characteristics in region 36.

It is expected that during the life of this patent many relevant detectors will be developed and the scope of the term “detector” is intended to include all such new technologies a priori.

Reference is now made to FIG. 2b, which is a schematic illustration of an apparatus 80 for manipulating an object present in a fluid by electrokinetics, according to various exemplary embodiments of the present invention. The principles and operations of apparatus 80 are similar to the principles and operations of device 10 and/or 30 above, except that in apparatus 80, one or more of the electrode structures are detachable from the apparatus. This embodiment is particularly useful when it is desired to replace the electrode structures and/or the flow chamber.

Thus, according to the presently preferred embodiment of the invention apparatus 80 comprises substrate 12 having formed thereon or being integrated with one or more electrically floating electrode structures 18. Substrate 12 forms flow chamber 14 as further detailed hereinabove. Optionally, apparatus 80 also comprises substrate 20 as further detailed hereinabove. Substrates 12 and/or 20 can be made disposable.

Apparatus 80 further comprises an electrically activable device 82, having electrically biasable electrode structures 16 as further detailed hereinabove. Structures 16 can be formed on or integrated with a substrate 86 which is preferably made of electrically insulating or dielectric material, such as, but not limited to, glass, silicon dioxide, resistive (non-conductive) silicon, plastics (such as, but not limited to, those used for printed circuit board substrates), elastomers (e.g., poly-dimethylsiloxane), insulating photoresists (e.g., SU-8), ceramic or the like. For example, substrate 86 can be made of the same material as substrate 12. Device 82 is designed and constructed to receive substrate 12 and/or 20 and to generate an electric field in a region 84 engaged by the substrate(s). Device 82 preferably serves as housing for substrate 12 and optionally substrate 20, and typically comprises a recess or slot 88 which is sizewise and shapewize compatible with the substrate(s).

Apparatus 80 can comprise any of the aforementioned components of microfluidic device 30, including, without limitation, power source device 32, ports 38 and 40, fluid flow driving system 42 and detector 34.

The device of the present embodiments can be manufactured by fabricating a plurality of electrode structures in a chamber, which can be, for example, a substrate made of glass or any other insulating and/or dielectric material, and fabricating a plurality of electrical contacts in the chamber, such that a portion of the electrode structures are connected to the electrical contacts, and one or more electrode structures remains insulated from the contacts and the other electrodes. The electrode structures can be of similar (e.g., micrometric) size, or, more preferably, the floating electrode structure can be characterized by one or more nanometric dimensions, as further detailed hereinabove.

The fabrication of electrodes can be by any constructive and/or destructive fabrication technique or process known in the art, including, without limitation, evaporation, lithography, lift-off, spattering, e-beam lithography, focused ion beam milling and the like. For example, a metal, preferably Titanium followed by Gold, can be deposited on the chamber by acceleration of particles within a vacuum tube. The selection of Titanium and Gold is due to the known properties of these metals to adhere well to each other and to a glass substrate. Alternatively, an aluminum layer can be deposited on the chamber using an electron-beam evaporator.

The electrical contacts can be fabricated, for example, by patterning and evaporation of a conductive material, onto the chamber.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

### Example 1

### Mathematical Formulae

A particle subjected to a nonuniform electric field ({tilde under (E)}) experiences polarization. The electric force ({tilde under (F)}_{elect}) acting upon the particle is a function of the field distribution and the dielectric polarization components induced in the particle by the field. If the particle is neutral or an alternating field whose time average is zero is applied, the electric force resulting from net charge vanishes. In this case, the dipolar moment induced in the particle and the field gradient values dominate the electric force. The resulting force can be approximated as:

[symbol]

{tilde under (F)}_{elect} [symbol] =2π∈ₘR³[Re{f_{CM}}∇{tilde under (E)}ᵣₘₛ²+Im{f_{CM}}(Eₓ²∇φₓ+E_{y}²∇φ_{y}+E_{z}²∇φ_{z})], (EQ. 1)

where [symbol] is the time averaged value of x, ∈ₘ is the medium permittivity, R is the particle radius, Re{x} and Im{x} are the real and imaginary components of x respectively, ∇ is the gradient operator, {tilde under (E)}ᵣₘₛ is the root mean square electric field, Eᵢ is the electric field component in the direction i, φᵢ is the phase of the electric field component Eᵢ and f_{CM} is the frequency (ω=2πf) dependent Clausius-Mossotti factor of the first order:

$${f}_{CM} ( ω ) = \frac{{ɛ}_{p}^{*} - {ɛ}_{m}^{*}}{{ɛ}_{p}^{*} + 2 {ɛ}_{m}^{*}} , \qquad ( EQ . 2 )$$

∈ₚ*, ∈ₘ* are the complex conjugate permittivities of the particle and the medium, respectively:

$${ɛ}_{p}^{*} = {ɛ}_{p} - j \frac{{σ}_{p}}{ω} ; {ɛ}_{m}^{*} = {ɛ}_{m} - j \frac{{σ}_{m}}{ω} , \qquad ( EQ . 3 )$$

j²=−1, σₚ, σₘ are the conductivities of the particle and the medium respectively and ∈ₚ is the particle permittivity.

The dielectrophoretic force {tilde under (F)}_{DEP} exists when the intensity and/or the phase of the applied electric field is nonuniform. The classic dielectrophoretic force is proportional to the intensity gradient ∇{tilde under (E)}ᵣₘₛ² (first term of Equation 1) and the traveling-wave dielectrophoretic force is proportional to the phase gradient ∇φᵢ (second term in Equation 1).

Generally, the dielectrophoretic force depends on the particle volume (R³). The direction of the dielectrophoretic force depends on the polarity of the induced dipolar moment which is determined by the conductivities and permittivities of the particle and its suspending medium, as given by Equation 2 above. The dielectrophoretic force is highly selective. It can change significantly for particles that are not very different from each other, such as viable and nonviable cells.

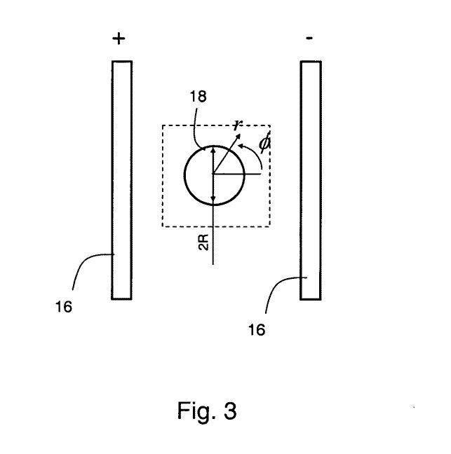

Reference is now made to FIG. 3 which is a schematic illustration of device 10 in an exemplified embodiment in which the device comprises two electrically biasable electrode structures 16 and a single cylindrical floating electrode structure 18. In the absence of structure 18, the electric field between structures 16 is uniform: {tilde under (E)}={tilde under (E)}₀.

The cylindrical floating electrode structure alters the electric field in the device. The expressions for the electric field and the field intensity gradient become:

$$\begin{matrix}{E}_{\%} = {{E}_{0}}_{\%} [ 1 + {( \frac{R}{r} )}^{2} ] cos φ {\hat{i}}_{r} - {{E}_{0}}_{\%} [ 1 - {( \frac{R}{r} )}^{2} ] sin φ {\hat{i}}_{φ} & ( EQ . 4 ) \\ ∇ {{E}^{2}}_{\%} = - 4 {{E}_{0}^{2}}_{\%} [ cos 2 φ \frac{{R}^{2}}{{r}^{3}} + \frac{{R}^{4}}{{r}^{5}} ] {\hat{i}}_{r} - 4 {{E}_{0}^{2}}_{\%} \frac{{R}^{2}}{{r}^{3}} sin 2 φ {\hat{i}}_{φ} , & ( EQ . 5 )\end{matrix}$$

where R is the floating cylinder radius, r is the radial coordinate, φ is the angular coordinate, îᵣ is the radial unit vector and î_{φ} is the angular unit vector (see FIG. 3).

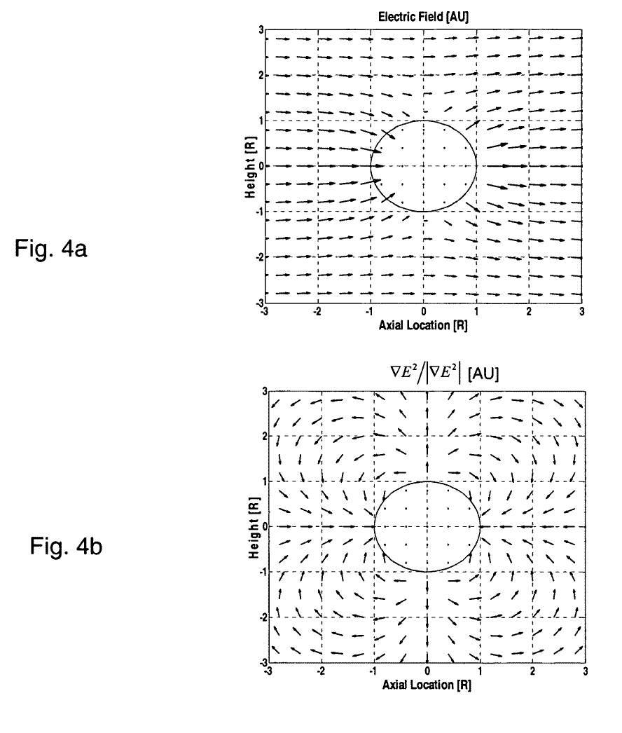

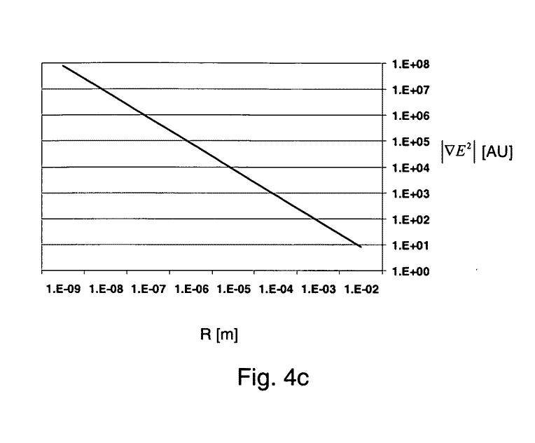

FIGS. 4a-b illustrate the electric field and the normalized field intensity gradients

$$∇ {{E}^{2}}_{\%} / \vert ∇ {{E}^{2}}_{\%} \vert$$

as obtained from Equations 4 and 5, respectively. The results are displayed in the vicinity of the cylindrical floating electrode (the dashed rectangle shown in FIG. 3). The geometric dimensions of the model are normalized by the radius of the cylinder R.

FIG. 4c shows the field intensity gradients in the vicinity of the cylindrical floating electrode structure as a function of the radius of the cylinder R. As shown, the field intensity gradient is inversely proportional to R. Thus, dielectrophoretic forces in the vicinity of a nanoscale floating cylinder are expected to be three orders of magnitude larger than those in the vicinity of a microscale cylinder.

### Example 2

### Simulations

Computer simulations of the electrical field within two types of model devices were performed.

### Methods

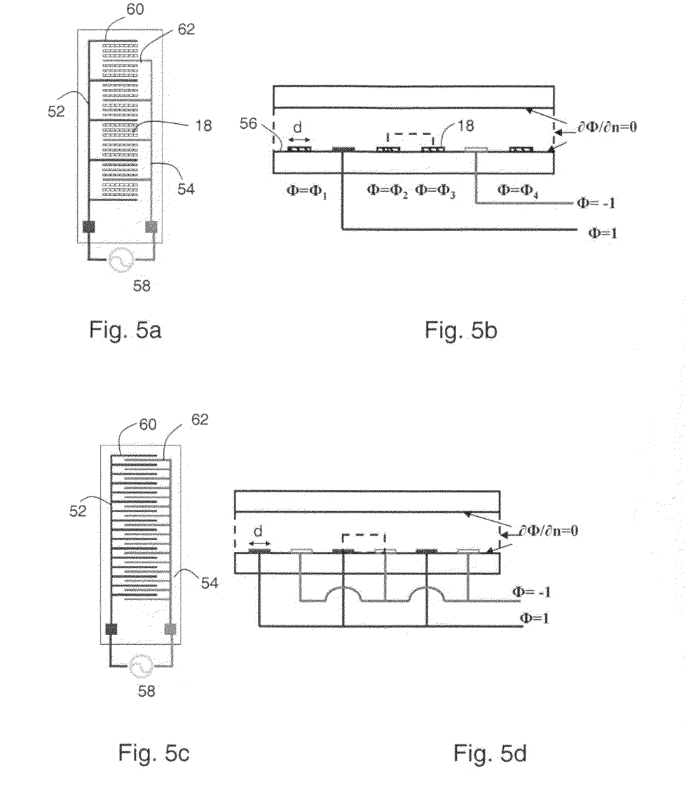

The model devices are schematically illustrated in FIGS. 5a-d. A first model device, illustrated in FIGS. 5a (top view) and 5b (fragmentary side view) was designed according to a preferred embodiment of the present invention and included both electrically biasable electrode structures and electrically floating electrode structures. The electrically biasable electrode structures were arranged in an interdigitated arrangement.

As illustrated in FIG. 5a, the electrically biasable electrode structures comprise first electrode stem 52, disposed proximate to the substrate surface 56 and parallel with a second electrode stem 54, proximate to the same surface. The first electrode stem is connected to a first terminal of an AC power source 58, and the second electrode stem is connected to a second terminal of power source 58, such that that the first electrode stem and the second electrode stem have opposite polarities. A series of first electrode “digits” 60 extend in a substantially normal direction from first electrode stem 52 towards second electrode stem 54, without touching the second electrode stem. Similarly, a series of “digits” 62 of second electrode stem 54 extend in a substantially normal direction from the second electrode stem towards the first electrode stem, without touching the first electrode stem. First electrodes digits 60 are spaced so that the digits are adjacent to and substantially parallel with second electrode digits 62. As a result of the alternating arrangement of interdigitated electrodes 60 and 62, an electrode having one polarity at a given moment is adjacent to one or more electrodes having the opposite polarity.

The electrically floating electrodes 18 are disposed in the gaps between adjacent electrode digits 60, 62. Simulations were performed both for floating electrodes characterized by micrometric dimensions and for floating electrodes characterized by nanometric dimensions. The configuration illustrated in FIGS. 5a-b is referred to hereinunder as the floating electrode dielectrophoresis (feDEP) configuration.

A second model device, illustrated in FIGS. 5c (top view) and 5d (fragmentary side view) included only electrically biasable electrode structures arranged in an interdigitated arrangement. The configuration illustrated in FIGS. 5c-d is referred to hereinunder as the traditional dielectrophoresis configuration.

In both model devices, a phase sequence of half a cycle was applied to the biasable electrodes. The biasable electrodes were simulated as being applied by alternating voltages of amplitude V₀. The voltages were used as boundary conditions for the simulations. The voltages were normalized so as to provide a dimensionless potential Φ, defined as the applied voltage divided by V₀. Thus, Φ alternates between 1 and −1 at the electrodes.

The model devices for floating electrodes characterized by micrometric dimensions included nine electrodes, enumerated serially from 1 to 9. In the traditional dielectrophoresis configuration, all nine electrodes were biased, and in the floating electrode dielectrophoresis configuration electrode Nos. 3 and 7 were biased and electrodes Nos. 1, 2, 4, 5, 6, 8 and 9 were floating electrodes. The model devices for floating electrodes characterized by nanometric dimensions included eight electrodes, enumerated serially from 1 to 8. Electrode Nos. 3 to 6 were floating and electrodes Nos. 1, 2, 7 and 8 were biased electrodes.

An electric isolation condition was imposed as a Dirichlet boundary condition of zero normal electric field (∂Φ/∂n=0) at all boundaries other than the electrodes. The floating electrodes in the first device were modeled as equipotential perfect electric conductors, and zero tangential electric field was imposed thereat. Additionally, a zero net charge was imposed on each floating electrode. The dimensionless potentials at different floating electrodes (denoted in FIG. 5b by (Φᵢ, i=1, 2, . . . ) were initially unknown and were calculated by finite element method. The equipotential constraints at the floating electrode were therefore not Dirichlet boundary conditions.

A commercial finite element simulation software ANSYS® was used for calculating the electric fields. MATLAB® software was used for studying and visualizing the field intensity gradients.

The electric field generated in the configuration of FIGS. 5c-d is spatially periodic and can be solved by modeling only a single electrode. Yet, to avoid numeric discrepancies that may occur when a finite element mesh is changed, a single mesh was maintained for all the microscale floating electrode configurations studied. Unlike the configuration in FIG. 5c-d, there is a-priori no spatial periodicity when floating electrodes are incorporated. The mesh therefore contained all the nine electrodes used. The geometric dimensions of the models were normalized by the characteristic length of the electrode width, indicated by d in FIGS. 5b and 5d.

### Results

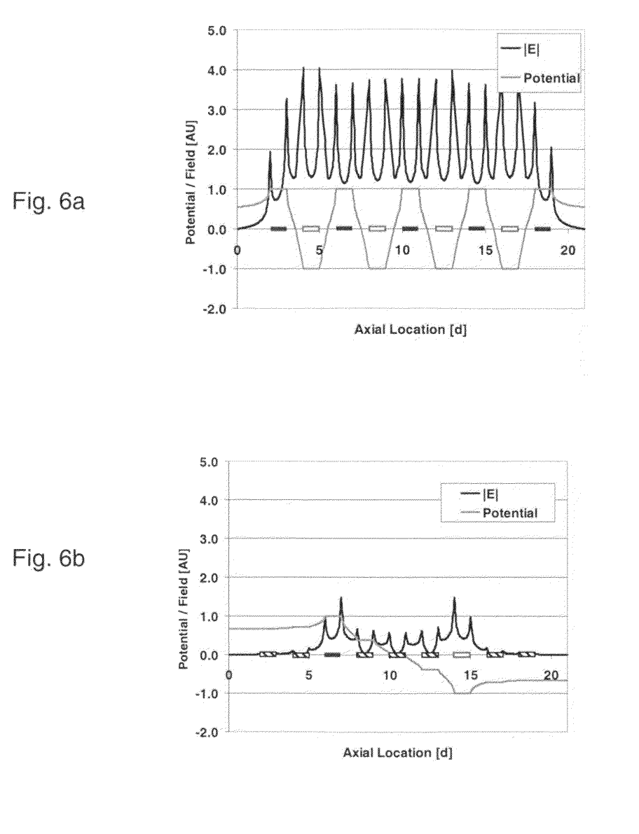

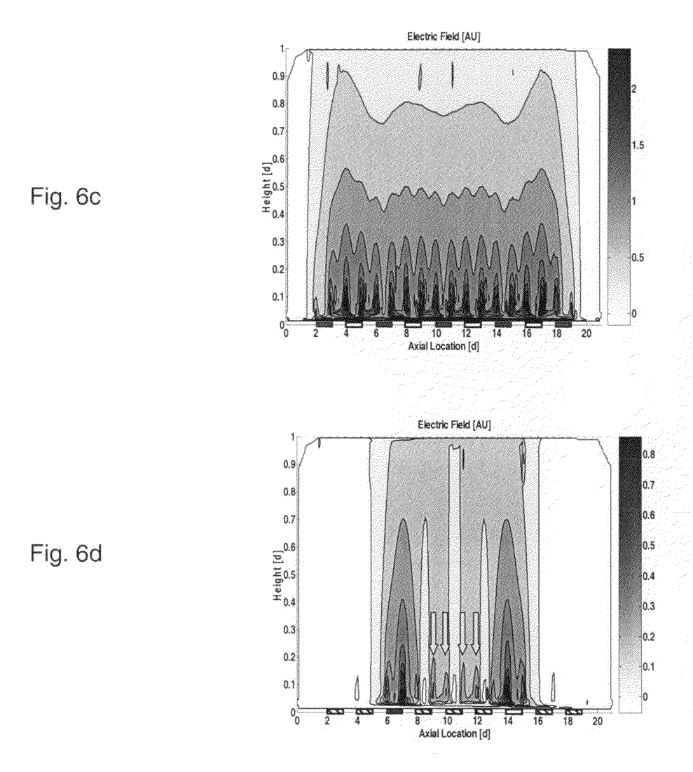

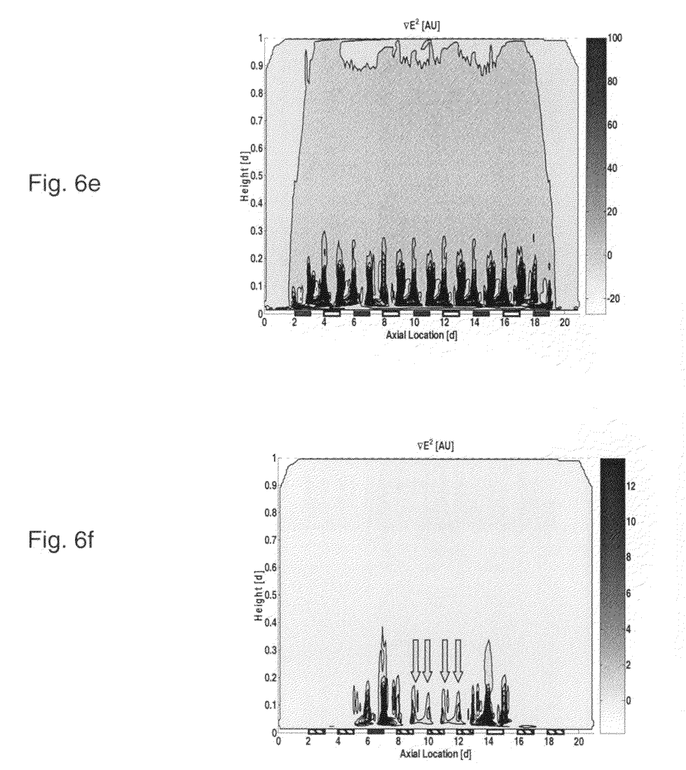

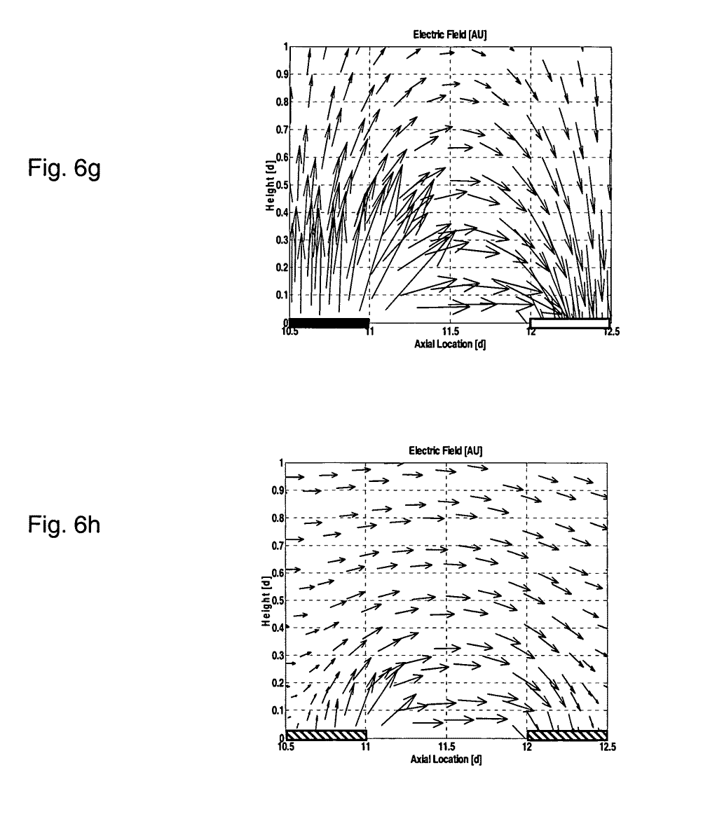

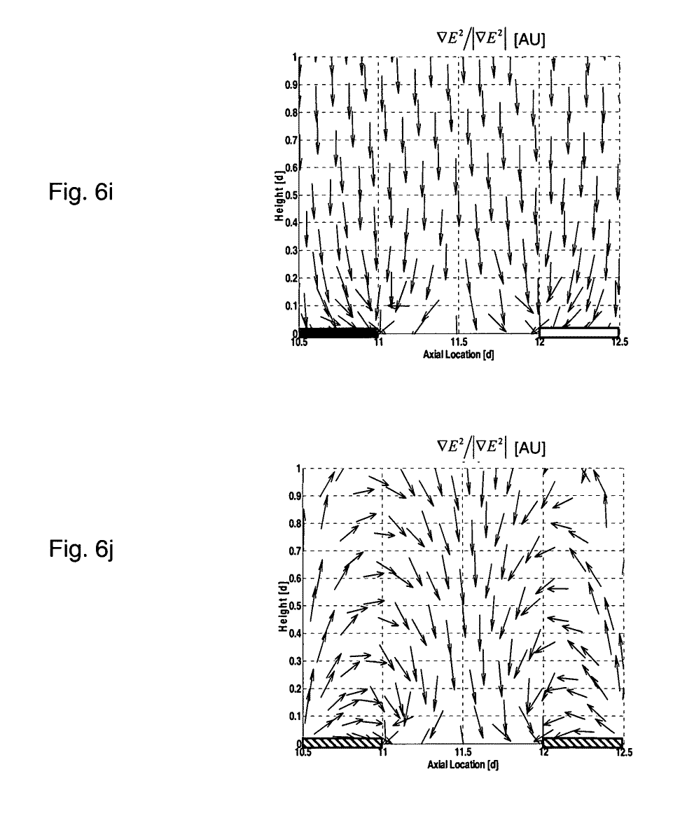

The numerical calculations for the microscale floating electrode case are presented in FIGS. 6a-j, where FIGS. 6a-b show the dimensionless potential and the electric field intensity (|E|) along the electrode plane for the traditional (FIG. 6a) and floating electrode (FIG. 6b) configuration; Figures c-d show iso-contours of the field intensity for the traditional (FIG. 6c) and floating electrode (FIG. 6d) configuration; FIGS. 6e-f show iso-contours of the field intensity gradient for the traditional (FIG. 6e) and floating electrode (FIG. 6f) configuration; FIGS. 6g-h show vector representation of the electric field between two adjacent electrode centers for the traditional (FIG. 6g) and floating electrode (FIG. 6h) configuration; and FIGS. 6i-j show vector representation of the normalized field intensity gradient between two adjacent electrode centers for the traditional (FIG. 6i) and floating electrode (FIG. 6j) configuration.

Referring to FIGS. 6a, 6c, 6e, 6g and 6i (traditional dielectrophoresis configuration), the potential alternates between 1 and −1 and the changes are nearly linear between the electrodes (FIG. 6a). The electric field increases as it approaches the electrode plane (FIG. 6c). It is normal to the plane at the electrode and tangential to the plane at the glass substrate (FIG. 6g). The highest field intensities and field intensity gradients appear at electrode edges (FIGS. 6c and 6e). It is noted that Equation 1 shows that the field intensity gradient represents the orientation of the dielectrophoretic force. The force is therefore normal to the electrode plane, directed downward and points towards electrode edges near the metallization (FIG. 6i).

FIGS. 6b, 6d, 6f, 6h and 6j show the simulation results for the floating electrode dielectrophoresis configuration. The field intensities and field intensity gradients are substantially different from those of the traditional dielectrophoresis configuration.

In the floating electrode dielectrophoresis configuration, only the third and seventh electrodes from the left are biased with external voltage. The remaining electrodes are floating electrodes. The potential reaches values of 1 and −1 at the biased electrodes 3 and 7, respectively (FIG. 6b). The floating electrodes are equipotential. Floating electrode Nos. 4-6 which are located between the biased electrodes are indicated by arrows. The potential values of floating electrode Nos. 4-6 exhibit a nearly linear decrease from 1 to −1.

The potential values of the floating electrode Nos. 1-2 and 8-9 which are located outside the biased electrodes are also affected. For these electrodes, however, the potential values do not exhibit linear behavior. The electric field increases as it approaches the electrode plane (FIG. 6d).

The highest field intensity values were obtained at the biased electrode edges (FIG. 6f). Nevertheless, the floating electrodes were also affected and exhibited high field intensity values at their edges, as indicated by the arrows. The edges of floating electrode Nos. 4-6 are indicated by arrows. These floating electrodes were more affected than the floating electrodes outside the biased electrodes.

The field between two adjacent floating electrodes was normal to the plane at the electrode and tangential to the plane at the glass substrate (FIG. 6h). However, the dielectrophoretic force distribution at the floating electrodes was different (FIG. 6j). The force was directed upwards above the electrodes and downwards therebetween. In the vicinity of the electrode, the force points towards the electrode edges. Such a force distribution tends to move the particles positioned above electrodes up and move the particles positioned between electrodes down. Yet, all the particles are expected to collect at the electrode edges.

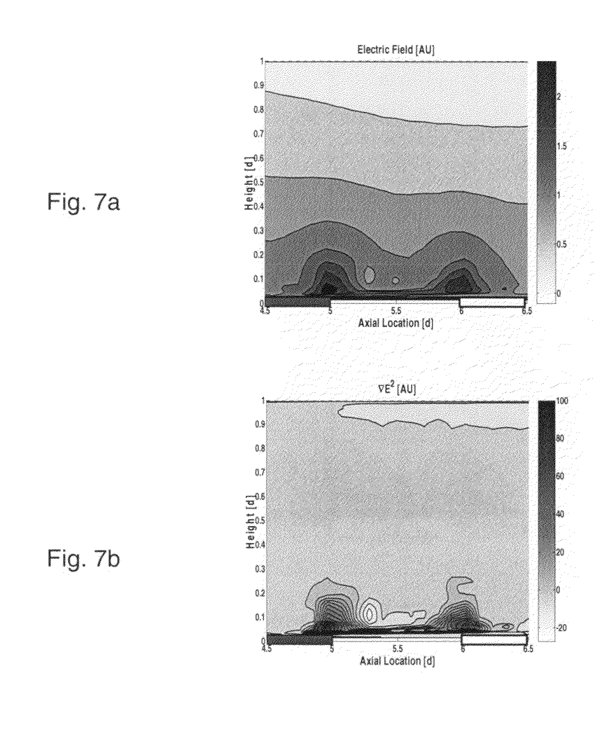

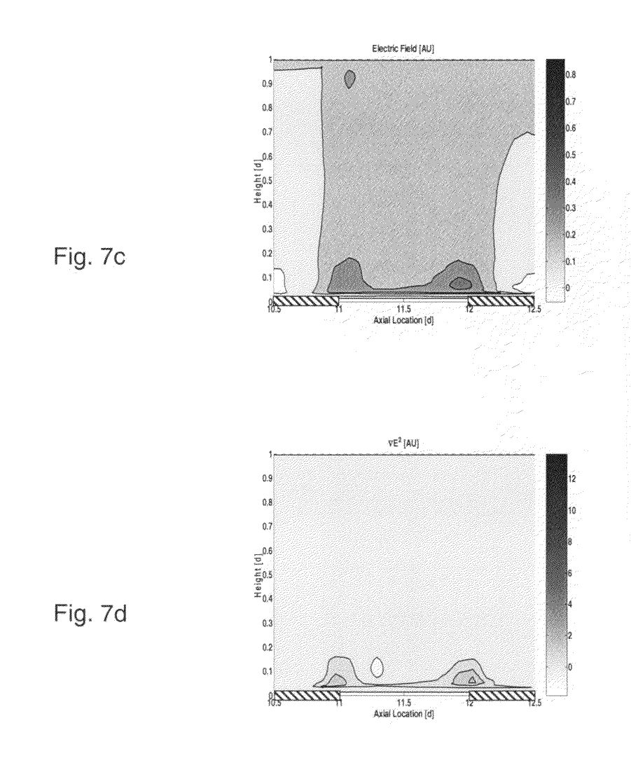

FIGS. 7a-b show the results of finite element calculations for the traditional dielectrophoresis device. The results relate to a representative region between two adjacent biased microelectrode centers (the dashed rectangle illustrated in FIG. 5d). The filled and empty bars at the bottom of each figure represent the biased electrodes (as illustrated in FIG. 5d). The highest field intensities and field intensity gradients were obtained at the edges of the biased electrodes.

FIGS. 7c-d show the results of finite element calculations for the floating electrode dielectrophoresis configuration in which the floating electrodes were simulated as having micrometric size. The results relate to a representative region between two adjacent floating electrode centers (the dashed rectangle seen in FIG. 5b). The patterned bars at the bottom of each figure represent the floating electrodes (as illustrated in FIG. 5b). The floating electrode dielectrophoresis configuration resulted in field intensities and field intensity gradients that are different from those of the traditional dielectrophoresis configuration. Nevertheless, the floating electrodes also exhibited the highest field intensities and field intensity gradients at their edges. Therefore, particles are expected to collect at the floating electrode edges as well as at biased electrode edges.

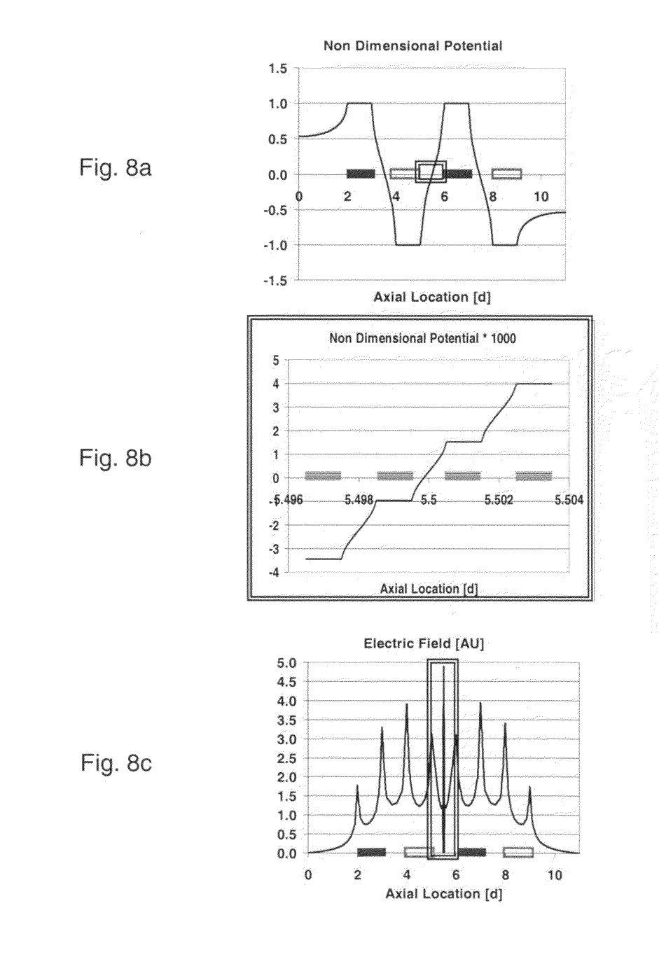

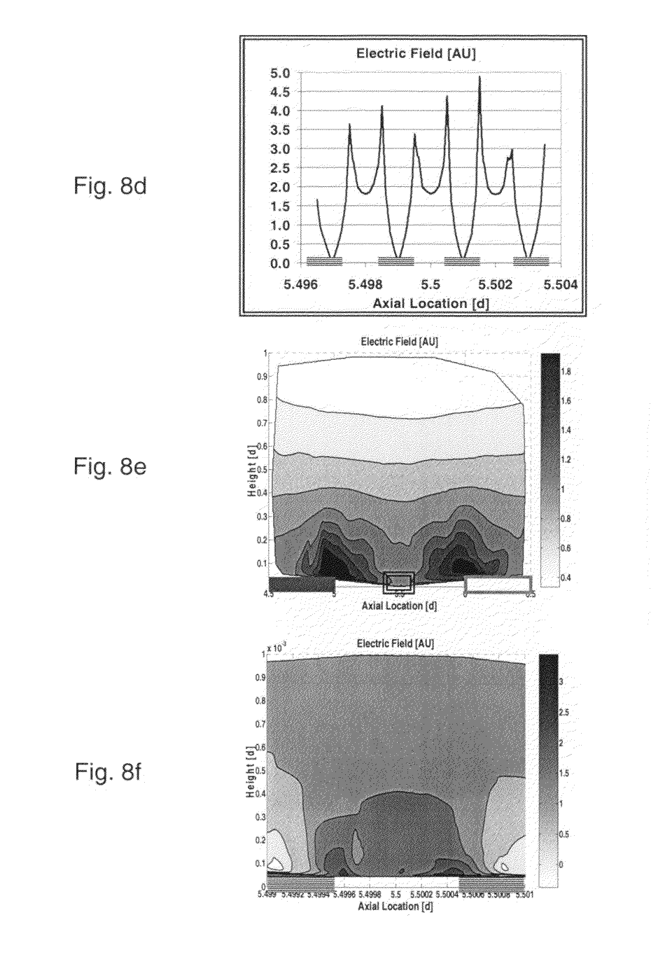

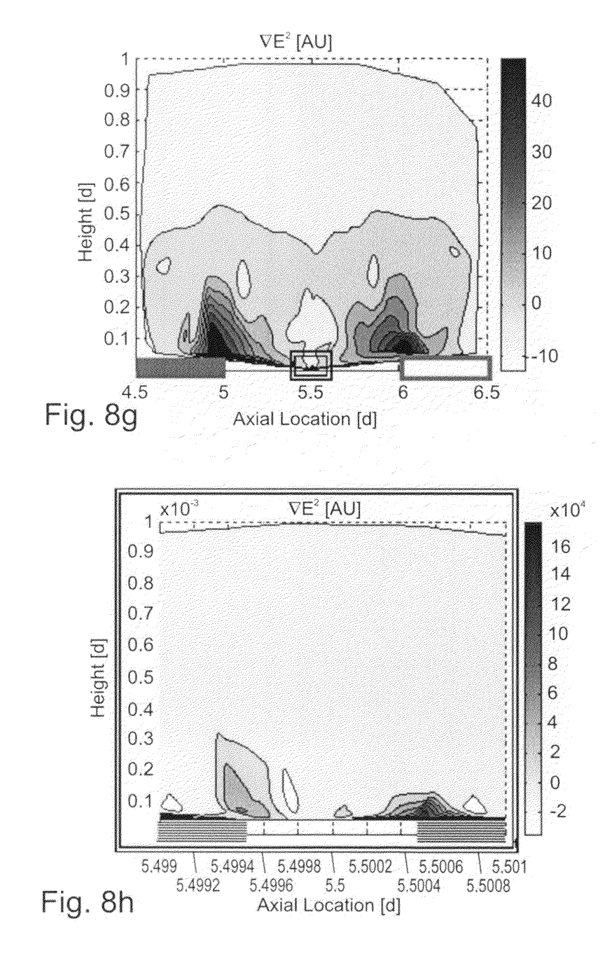

FIGS. 8a-h show the results of finite element calculations for the floating electrode dielectrophoresis configuration in which the floating electrode were simulated as having nanometric size. The results are displayed on two different size scales. The scale in FIGS. 8a, 8c, 8e and 8g represents the microscale spacing between the biased electrodes, and the scale in FIGS. 8b, 8d, 8f and 8h represents the nanoscale spacing between the floating nanoelectrodes.

As shown in FIG. 8a, the dimensionless potential alternated between 1 and −1 at the biased microelectrodes. As shown in FIG. 8b, the floating nanoelectrodes were equipotential, and the potential at each floating nanoelectrode was unique and different from the potential at other floating nanoelectrodes. Thus, Φᵢ≠Φⱼ for i≠j. The potential values of the nanoelectrodes were determined by capacitive coupling to the biased microelectrodes, and are consistent with the spatial distribution of the potential imposed by the biased microelectrodes. For the region presented in FIG. 8b, located approximately in the middle between adjacent biased microelectrodes, the potential is expected to be nearly zero.

FIGS. 8c-d show the obtained electric field values. Maximal values of the electric field were obtained at the electrode edges. There was no significant difference between field intensity values at the biased microelectrodes and field intensity values at the floating nanoelectrodes.

FIGS. 8e-h show the electric field intensity and field intensity gradient distributions. In FIGS. 8e and 8g, the electric field intensity and field intensity gradient distributions are shown for a region between adjacent biased microelectrode centers (microscale region). In FIGS. 8f and 8h the electric field intensity and field intensity gradient distributions are shown for a region between adjacent floating nanoelectrode centers (nanoscale region). In both the microscale and nanoscale regions, the highest field intensities and field intensity gradients were obtained at the electrode edges. The electric field values at the biased microelectrodes and at the floating nanoelectrodes are similar (FIGS. 8e-f). Still, the field intensity gradients at the floating nanoelectrodes were increased by a factor of 2500 in comparison to those at the biased microelectrodes (FIGS. 8g-h).

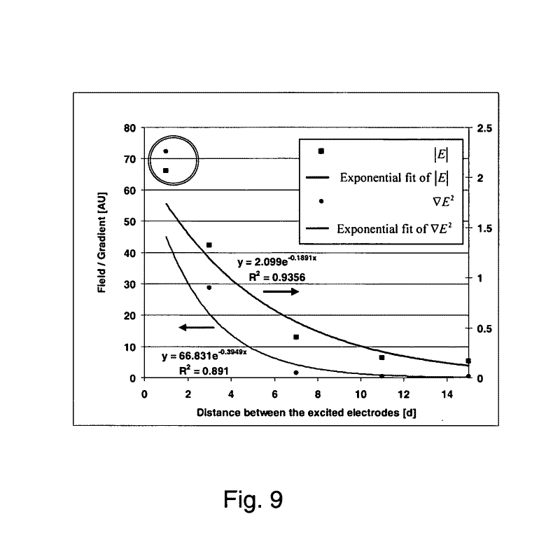

FIG. 9 shows the effect of the distance between the biased electrodes on the field intensity and field intensity gradient at the floating electrode edges, for the floating electrode dielectrophoresis configuration in which the floating electrodes were simulated as having micrometric size. The distance between the biased electrodes is a function of the number of floating electrodes located between the biased electrodes. In FIG. 9, the obtained values for the field intensity are shown as filled squares, and the obtained values for field intensity gradient are shown as filled circles. Also shown are curves representing numerical fits to the obtained values. The field intensity and field intensity gradient decreased generally exponentially with the distance between the biased electrodes. For the field intensity, the numerical fit was 2.099 exp(−0.1891x), with a squared Pearson coefficient of 0.9356, and for the field intensity gradient, the numerical fit was 66.831 exp(−0.3949x), with a squared Pearson coefficient of 0.891, where x is the distance between the biased electrodes normalized to the electrode width d as defined in FIGS. 5b and 5d.

### Example 3

### Prototype Device

A prototype device was manufactured in accordance with preferred embodiments of the present invention. The prototype device was used for manipulating erythrocytes in blood sample.

### Materials and Methods

Two different electrode configurations were fabricated. The two electrode configurations had different feature sizes and were fabricated using different processes and materials.

In a first configuration, each electrode was 12.5 μm in width, and adjacent electrodes were separated by a 12.5 μm gap. A 200-Å-thick titanium and a 2000-Å-thick gold layers were subsequently deposited on a microscope slide using an electron-beam evaporator. The Ti/Au electrodes were obtained using a lift-off process. The obtained device included various electrode layouts in an arrangement in which 7-8 floating electrodes were located between or adjacent to two biasable electrodes. The number of the floating electrodes and their arrangement in relation to the biased electrodes was controlled by changing the bias connection from electrode to electrode within the array.

In a second configuration, each electrode was 25 μm in width and adjacent electrodes were separated by a 25 μm gap. A 7000-Å-thick aluminum layer was deposited on a soda lime glass wafer using an electron-beam evaporator. The electrodes were obtained using an aluminum etching process. The obtained device included an electrode arrangement in which 7-8 floating electrodes were located between or adjacent to two biasable-electrodes. The number of the floating electrodes and their arrangement in relation to the biased electrodes was controlled by changing the bias connection from electrode to electrode within the array.

Fresh whole blood was obtained from white male Spargue Dawley rats. All animals were older than three months and weighed about 250 grams. The blood was drawn from the aorta prior to animal sacrifice into a syringe washed with an anticoagulant (heparine choay, 5000 U.I./1 ml). A suspending buffer was prepared by diluting PBS (Dulbecco's Phosphate Buffered Saline—D8662, Sigma Aldrich) with deionized water to give a range of conductivities. Standard dilution of the blood was performed by using the suspending buffer at a 1:100 ratio. The conductivity of the sample was measured using a conductivity meter (Fluke 179).

The devices were contacted by the sample and a 1 MHz, 10 V (peak to peak) voltage was applied to the biasable electrodes.

Erythrocyte motion was visually recorded with a Nikon VM Lens adapter on a Nikon SMZ800 microscope equipped with a Sony SSC-M370CE high resolution CCD camera. Digital output from the camera was routed to a computer with a National Instruments IMAQ PCI 1411 video capture card. LabVIEW 7.1 software (National Instruments) was used for controlling the recording parameters. AC voltage was applied to the electrodes from an Agilent HP33220A function generator. Waveforms were monitored with a Tektronix TDS 1002-60 MHz oscilloscope.

### Results

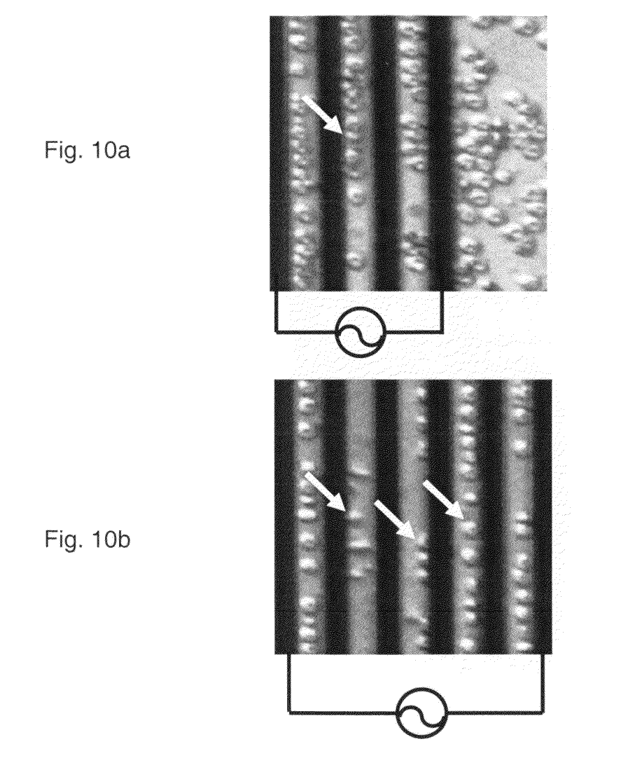

FIGS. 10a-b show two video images captured in the experiments. The biased electrodes are marked by solid lines symbolizing the function generator and the voltage connections. The remaining electrodes are floating electrodes. The images in the figures correspond to the first prototype device (Ti/Au electrodes, lift-off technique). FIGS. 10a-b demonstrate erythrocyte collection at floating electrode edges, as indicated by white arrows, thus demonstrating that the erythrocytes experienced positive dielectrophoresis.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A device for manipulating an object present in a fluid by electrokinetics, the device comprising a substrate forming a flow chamber and having formed thereon or being integrated with a plurality of electrically biasable electrode structures and at least one electrically floating electrode structure.

2. The device of claim 1, wherein said at least one electrically floating electrode structure is designed and configured to control non-uniformities in an electric field generated upon application of bias to said plurality of electrically biasable electrode structures.

3. The device of claim 1, wherein said at least one electrically floating electrode structure is designed and configured to increase non-uniformities in an electric field generated upon application of bias to said plurality of electrically biasable electrode structures.

4. (canceled)

5. (canceled)

6. Apparatus for manipulating an object present in a fluid by electrokinetics, the apparatus comprising:
a substrate forming a flow chamber and having formed thereon or being integrated with at least one electrically floating electrode structure; and
an electrically activable device, having a plurality of electrically biasable electrode structures and being designed and constructed to receive said substrate and to generate an electric field in a region engaged by said substrate.

7. The apparatus of claim 6, wherein said at least one electrically floating electrode structure is designed and configured to control non-uniformities in said electric field.

8. The apparatus of claim 6, wherein said at least one electrically floating electrode structure is designed and configured to increase non-uniformities in said electric field.

9. A method of fabricating a device for manipulating an object by electrokinetics, comprising:
fabricating a plurality of electrode structures in a chamber;
fabricating a plurality of electrical contacts in said chamber; and
connecting a portion of said plurality of electrode structures to said plurality of electrical contacts, so as to provide a plurality of electrically biasable electrode structures while maintaining and at least one electrically floating electrode structure, said at least one electrically floating electrode structure being designed and configured to increase non-uniformities in an electric field generated upon activation of said plurality of electrically biasable electrode structures.

10. The device of claim 1, wherein at least one of said plurality of electrically biasable electrode structures and said at least one floating electrode structure is characterized by at least one micrometric dimension.

11. The device of claim 1, wherein at least one of said plurality of electrically biasable electrode structures and said at least one floating electrode structure is characterized by at least one nanometric dimension.

12. The device of claim 1, wherein said electrically biasable electrode structures are characterized by at least one micrometric dimension and said at least one floating electrode structure is characterized by at least one nanometric dimension.

13. The device of claim 1, wherein said at least one electrically floating electrode structure is designed and constructed to increase a dielectrophoretic force exerted on the object by at least an order of magnitude.

14. The device of claim 1, wherein said at least one electrically floating electrode structure is designed and constructed to increase a dielectrophoretic force exerted on the object by at least two orders of magnitude.

15. The device of claim 1, wherein at least one electrically floating electrode structure is designed and constructed to increase a dielectrophoretic force exerted on the object by at least three orders of magnitude.

16. The device of claim 1, wherein at least one electrically floating electrode structure is designed and constructed to increase a dielectrophoretic force exerted on the object by more than three orders of magnitude.

17. The device of claim 1, wherein said plurality of electrically biasable electrode structures comprises interdigitated electrodes.

18. The device of claim 1, wherein said electrically floating electrode structures comprise carbon nanotubes.

19. The device of claim 1, further comprising a power source device, electrically connected to said plurality of electrically biasable electrode structures and configured for applying bias thereto.

20. The device of claim 19, wherein said power source device is configured to provide out-of-phase signals to individual members of said plurality of electrodes.

21. The device of claim 20, wherein said out-of-phase signals are selected such as to generate a traveling wave dielectrophoretic force.

22. The device of claim 20, wherein said out-of-phase signals are selected such as to generate a classical dielectrophoretic force.

23. The device of claim 19, wherein said power source device is a direct-current power source device.

24. The apparatus of claim 6, further comprising a detector for detecting the presence of the object.

25. The apparatus of claim 24, wherein said detector is designed and constructed for detecting variations in the electrical characteristics in a predetermined region within said chamber.

26. The apparatus of claim 24, wherein said detector is designed and constructed for detecting variations in the optical characteristics in a predetermined region within said chamber.

27-38. (canceled)

39. The device of claim 1, wherein at least one of said at least one floating electrode structure is characterized by at least one nanometric dimension.
